(19) United States
(12) Patent Application Publication
(10) Pub. No.: US 2020/0344344 A1
(43) Pub. Date: Oct. 29, 2020

(54) ATTACHMENT FOR HANDHELD DEVICE

(71) Applicant: Lombardi Design & Mfg, Freeport, NY (US)

(72) Inventor: Warren Friedel, Uniondale, NY (US)

(21) Appl. No.: 16/859,358

(22) Filed: Apr. 27, 2020

Related U.S. Application Data
(60) Provisional application No. 62/839,286, filed on Apr. 26, 2019.

(51) Int. Cl. H04M 1/04; F16M 13/00; F16M 11/38; F16M 11/10

(52) U.S. Cl. CPC H04M 1/04; F16M 13/005; G06F 1/1626; F16M 11/10; F16M 11/38

(57) ABSTRACT

Exemplary embodiments of an attachment for a handheld device are provided. In some exemplary embodiments, an apparatus is provided for securing a handheld device, having an attachment body having a top portion, a flat bottom portion and a side portion between the top portion and flat bottom portion, and a securement portion having a bottom that is flush with the bottom portion of the attachment body. The securement portion has an aperture in the bottom of the securement portion leading into an opening that is enclosed by a top of the securement portion, and the flat bottom portion of the attachment body is configured to be attached to a handheld device such that the aperture is sealed when the attachment body is connected to the handheld device. The attachment body can be disc-shaped.

### CROSS-REFERENCE TO RELATED APPLICATIONS

This application relates to and claims priority from U.S. Provisional Patent Application Ser. No. 62/839,286 filed Apr. 26, 2019, the entire disclosure of which is incorporated herein by reference.

### FIELD OF THE DISCLOSURE

The present disclosure relates to exemplary embodiments of an attachment for a handheld device, and more particularly, to exemplary embodiments of an attachment for a handheld device, such as a mobile phone or case, to a user's hand.

### BACKGROUND INFORMATION

Handheld devices such as mobile phones can often slip from a user's hand often resulting in damage to the device, such as cracking of the touch screen or other body damage. It would be preferable to have an apparatus that can secure the handheld device to a user's hand so that the handheld device would not fall even if it slips from a user's hand. The present disclosure provides an attachment that can prevent a handheld device from falling by securing the handheld device to the user's hand.

### SUMMARY OF EXEMPLARY EMBODIMENTS OF THE DISCLOSURE

Exemplary embodiments of the present disclosure can provide for an attachment for a handheld device, where an attachment can be removably connected to a handheld device and a bracelet can be provided that is worn around a user's hand and secured to the attachment.

For example, in some exemplary embodiments, an apparatus for securing a handheld device is provided, comprising an attachment body having a top portion, a flat bottom portion and a side portion between the top portion and flat bottom portion, and a securement portion having a bottom that is flush with the bottom portion of the attachment body, wherein the securement portion has an aperture in the bottom of the securement portion leading into an opening that is enclosed by a top of the securement portion, and wherein the flat bottom portion of the attachment body is configured to be attached to a handheld device such that the aperture is sealed when the attachment body is connected to the handheld device.

In some exemplary embodiments, the attachment body can be disc-shaped. The diameter of the attachment body can range from approximately 0.5 inches to approximately 3 inches, and a thickness of the attachment body can range from approximately 0.01 inches to approximately 0.5 inches. In some exemplary embodiments, the side portion can extend higher than a top portion of the attachment body creating a lip between the side portion and the top portion of the attachment body.

The apparatus for securing a handheld device can further comprise a design provided on the top portion of the attachment body. The opening of the securement portion can be configured to secure a bracelet to the attachment body. In some exemplary embodiments, the securement portion can be connected to the side portion of the attachment body. In some exemplary embodiments, the securement portion can be integral with the attachment body. In some exemplary embodiments, the top of the securement portion can have a curved surface and the opening can be curved. In some exemplary embodiments, the flat bottom portion of the attachment body can be configured to be connected to a back side of the handheld device.

The apparatus for securing a handheld device can further comprise an adhesive provided on the flat bottom portion of the attachment body to secure the attachment body to the handheld device. In some exemplary embodiments, the apparatus can further comprise a removable film provided on the adhesive on the flat bottom portion of the attachment body. In some exemplary embodiments, the adhesive can be reusable such that the flat bottom portion of the attachment body can be removed from the handheld device and reconnected to the handheld device.

### BRIEF DESCRIPTION OF THE DRAWINGS

The foregoing and other objects of the present disclosure will be apparent upon consideration of the following detailed description, taken in conjunction with the accompanying drawings, and claims, in which like reference characters refer to like parts throughout, and in which:

FIG. 1 is a top perspective view of a handheld device attachment according to an exemplary embodiment of the present disclosure;

FIG. 2 is a bottom perspective view of a handheld device according to an exemplary embodiment of the present disclosure;

FIG. 3 is a top view of a handheld device attachment according to an exemplary embodiment of the present disclosure;

FIG. 4 is a bottom view of a protective material for a handheld device attachment according to an exemplary embodiment of the present disclosure;

FIG. 5 is a side view of a handheld device attachment according to an exemplary embodiment of the present disclosure;

FIG. 6 is a close-up view of a securement portion of the handheld device attachment according to an exemplary embodiment of the present disclosure;

FIG. 7 is a bottom view of a handheld device attachment according to an exemplary embodiment of the present disclosure;

FIG. 8 is cross-sectional view of a cosmetic container according to an exemplary embodiment of the present disclosure;

FIG. 9 is a perspective view of a handheld device attachment attached to a rear side of a handheld device according to an exemplary embodiment of the present disclosure;

FIG. 10 is a perspective view of a handheld device attachment worn around a wrist of a user according to an exemplary embodiment of the present disclosure; and

FIG. 11 is a perspective view of a handheld device attachment worn around a wrist of a user according to an exemplary embodiment of the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative embodiments. It is intended that changes and modifications can be made to the described embodiments without departing from the true scope and spirit of the subject disclosure.

### DETAILED DESCRIPTION OF EXEMPLARY EMBODIMENTS OF DISCLOSURE

Exemplary embodiments of the various methods and apparatuses will now be described with reference to the figures. The following description of the various embodiments is merely exemplary in nature and is in no way intended to limit the scope of the disclosure, its application, or uses.

The disclosed technology relates to an attachment for a handheld device. Specifically, the attachment is designed so that the attachment can be secured to a rear side of a handheld device and include a bracelet for attaching to a user's wrist.

The term “handheld device” can be defined as any handheld device, e.g., smartphones, cell phones, pagers, personal digital assistants (PDAs), tablet computers, electronic book devices, remote controls for electronics, etc. The term “handheld device” can also include any type of protective case or covering used in conjunction with the handheld device.

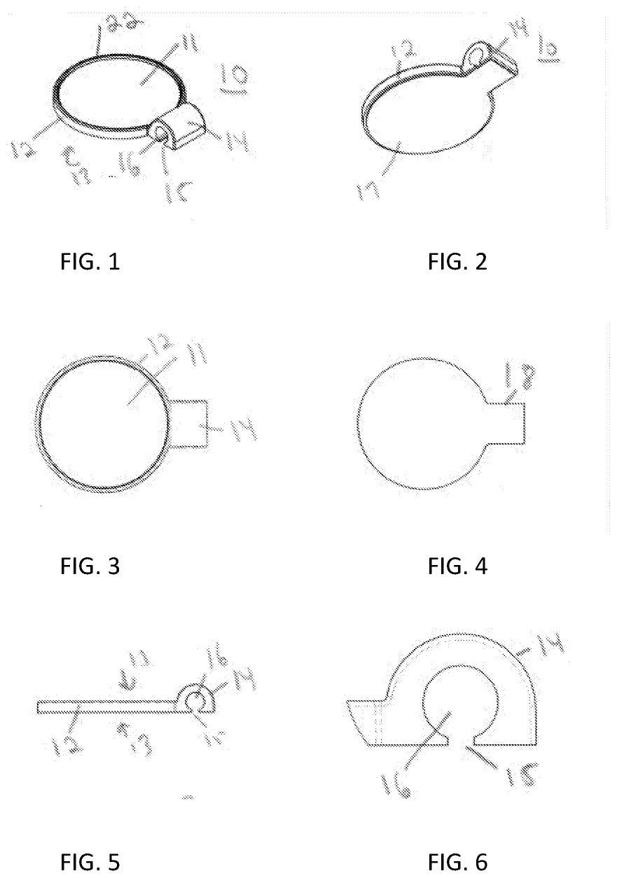

As shown in FIG. 1-11, an attachment 10 for a handheld device can include a top portion 11, sides 12, a bottom portion 13 and a bracelet securement portion 14. The bracelet securement portion 14 can be provided on a side 12. The bracelet securement portion 14 can be connected to the side 12 or can be integral with the side 12.

The attachment 10 can be manufactured using injection molding, however other manufacturing processes are contemplated. Injection molding is a manufacturing process for producing parts by injecting material into a mold. Injection molding can be performed with a host of materials, including metals, (for which the process is called die-casting), glasses, elastomers, confections, and most commonly thermoplastic and thermosetting polymers. After a product is designed, molds are made from metal, usually either steel or aluminum, and precision-machined to form the features of the desired part. Material for the part is (mixed then) fed into a heated barrel (hopper) and forced into a mold cavity through an injection gate, where it cools and hardens to the configuration of the cavity. Injection molding is widely used for manufacturing a variety of parts. Advances in 3D printing technology, using photopolymers which do not melt during the injection molding of some lower temperature thermoplastics, can be used for some simple injection molds. Parts to be injection molded must be very carefully designed to facilitate the molding process; the material used for the part, the desired shape and features of the part, the material of the mold, and the properties of the molding machine must all be considered. The versatility of injection molding is facilitated by this breadth of design considerations and possibilities.

In some exemplary embodiments, the attachment 10 can be disc-shaped and have a diameter ranging from approximately 0.5 inches to approximately 3 inches and a thickness ranging from approximately 0.01 inches to approximately 0.5 inches. Other shapes (such as but not limited to square, rectangle, oval) and dimensions are contemplated. For example, the dimensions can be bigger or smaller depending on the handheld device the attachment 10 is being secured to. In some implementations, the sides 12 of the attachment 10 can extend above than the top 11 so as to create a lip 22 between the sides 12 and top portion 11.

The bracelet securement portion 14 can include an aperture 15 and an opening 16 on a bottom area of the bracelet securement portion 14. The bracelet securement portion 14 can allow a bracelet 20 to be inserted into the aperture 15 and secured within the opening 16. A bottom of the bracelet securement portion 14 can be parallel with the bottom 13 of the attachment 10 so the attachment 10 and bracelet securement portion 14 are flush with the handheld device when connected, as will be explained below. A top of the bracelet securement portion 14 can be flush with or can be higher than the top 11 of the attachment 10. In some exemplary embodiments, the bracelet securement portion 14 can be curved and the opening 16 can be curved to engage a curved bracelet 20. Other shapes and dimensions are also contemplated, such as a square opening where the bracelet can have a square cross-section as well. The bracelet 20 can be made from any material, e.g. elastics, flexible silicone, metal chains, or any other material that allows for securement to a user's wrist.

After the bracelet 20 is secured within the opening 16, an adhesive 17 can be secured to a bottom 13 of the attachment 10. The adhesive 17 is two-fold in that (1) it can further secure and retain the bracelet 20 within the opening 16 and (2) secure the attachment 10 to a rear side of a handheld device 30, as shown in FIG. 9.

The adhesive 17 can be a double-sided tape or glue. In some implementations, the double-sided tape or glue can be a reusable type so that the attachment 10 can be removed and replaced on the handheld device 30. That is, the adhesive 17 can be reusable so that a user can (1) replace the bracelet 30 as needed, e.g., torn or worn, (2) change an ornamentation of the bracelet 30, e.g., color or type of material or (3) switch the attachment 10 to another handheld device.

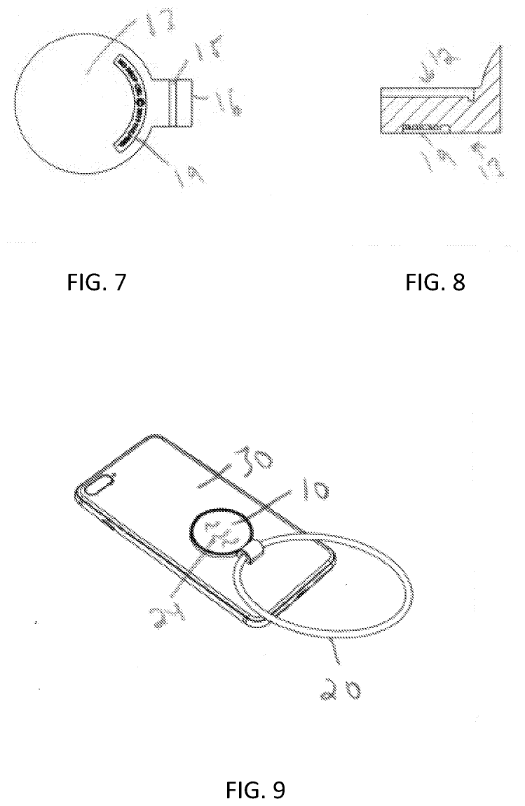

In some implementations, as shown in FIG. 7, a logo 19 can be provided on the bottom 13 of the attachment 10. In some implementations, an ornamental design 24 can be provided on the top 11 of the attachment 10.

During manufacture and packaging of the attachment 10, the adhesive 17 can be covered with a protective material 18 such as a removable film. The protective material 18 can be the same shape as the shape as a bottom 13 of the attachment 17. To secure the attachment 10 to a handheld device 30, the protective layer 18 can be peeled from the adhesive 17 and the attachment 10 with the adhesive 17 can be firmly secured to a handheld device 30, as shown in FIG. 9. In other words, the attachment 10 with bracelet 20 can be attached to a back side of a handheld device 30 for use.

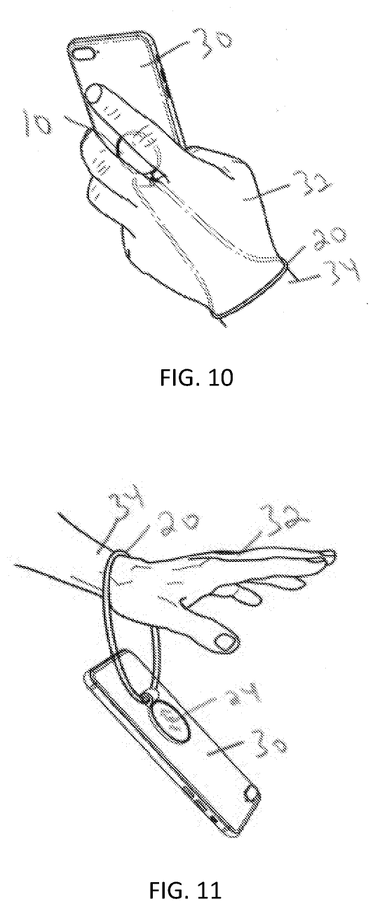

In use, when a user picks up the handheld device 30, the user can slide the bracelet 20 over a hand 32 and onto the user's wrist 34, as shown in FIG. 10. Now if the user accidentally lets go of the handheld device 30, as shown in FIG. 11, the handheld device 30 will dangle from the user's wrist 34 and will avoid damage by not hitting the floor or some other hard object.

While presently preferred embodiments have been described for purposes of the disclosure, numerous changes in the arrangement can be made by those skilled in the art. Such changes are encompassed within the spirit of the invention as defined by the appended claims.

Various other considerations can also be addressed in the exemplary applications described according to the exemplary embodiments of the present disclosure. For example, various materials may be used to construct the elements described in the figures. Various sizes and dimensions of the attachment 10 and bracelet 20 can also be provided, and are not limited by the sizes, dimensions, shapes and designs described above and in the figures.

The words “ranging”, “ranges from”, “ranges between” and other similar notations, are used herein interchangeably and are meant to include the first and second indicated numbers and all the fractional and integral numerals there between. It should be noted that where various embodiments are described by using a given range, the range is given as such merely for convenience and brevity and should not be construed as an inflexible limitation on the scope of the disclosure. Accordingly, the description of a range should be considered to have specifically disclosed all the possible sub-ranges as well as individual numerical values within that range.

The foregoing Detailed Description is to be understood as being in every respect illustrative and exemplary, but not restrictive, and the scope of the disclosed technology disclosed herein is not to be determined from the Detailed Description, but rather from the claims as interpreted according to the full breadth permitted by the patent laws. It is to be understood that the embodiments shown and described herein are only illustrative of the principles of the disclosed technology and that various modifications may be implemented by those skilled in the art without departing from the scope and spirit of the disclosed technology.

Those skilled in the art could implement various other feature combinations without departing from the scope and spirit of the disclosed technology. Although the embodiments of the present disclosure have been described with specific examples, it is to be understood that the disclosure is not limited to those specific examples and that various other changes, combinations and modifications will be apparent to one of ordinary skill in the art without departing from the scope and spirit of the disclosed technology which is to be determined with reference to the following claims.

What is claimed is:

1. An apparatus for securing a handheld device, comprising:
an attachment body having a top portion, a flat bottom portion and a side portion between the top portion and flat bottom portion; and
a securement portion having a bottom that is flush with the bottom portion of the attachment body;
wherein the securement portion has an aperture in the bottom of the securement portion leading into an opening that is enclosed by a top of the securement portion; and
wherein the flat bottom portion of the attachment body is configured to be attached to a handheld device such that the aperture is sealed when the attachment body is connected to the handheld device.

2. The apparatus for securing a handheld device of claim 1, wherein the attachment body is disc-shaped.

3. The apparatus for securing a handheld device of claim 2, wherein a diameter of the attachment body ranges from approximately 0.5 inches to approximately 3 inches, and a thickness of the attachment body ranges from approximately 0.01 inches to approximately 0.5 inches.

4. The apparatus for securing a handheld device of claim 1, wherein the side portion extends higher than a top portion of the attachment body creating a lip between the side portion and the top portion of the attachment body.

5. The apparatus for securing a handheld device of claim 1, further comprising:
a design provided on the top portion of the attachment body.

6. The apparatus for securing a handheld device of claim 1, wherein the opening of the securement portion is configured to secure a bracelet to the attachment body.

7. The apparatus for securing a handheld device of claim 1, wherein the securement portion is connected to the side portion of the attachment body.

8. The apparatus for securing a handheld device of claim 7, wherein the securement portion is integral with the attachment body.

9. The apparatus for securing a handheld device of claim 1, wherein the top of the securement portion has a curved surface and the opening is curved.

10. The apparatus for securing a handheld device of claim 1, wherein the flat bottom portion of the attachment body is configured to be connected to a back side of the handheld device.

11. The apparatus for securing a handheld device of claim 10, further comprising:
an adhesive provided on the flat bottom portion of the attachment body to secure the attachment body to the handheld device.

12. The apparatus for securing a handheld device of claim 11, further comprising:
a removable film provided on the adhesive on the flat bottom portion of the attachment body.

13. The apparatus for securing a handheld device of claim 11, wherein the adhesive is reusable such that the flat bottom portion of the attachment body can be removed from the handheld device and reconnected to the handheld device.
